(19) United States
(12) Patent Application Publication
(10) Pub. No.: US 2013/0133874 A1
(43) Pub. Date: May 30, 2013

(54) HEAT EXCHANGER FOR VEHICLE

(71) Applicants: Jae Yeon KIM, Hwaseong-si (KR); Wan Je CHO, Hwaseong-si (KR)

(72) Inventors: Jae Yeon KIM, Hwaseong-si (KR); Wan Je CHO, Hwaseong-si (KR)

(73) Assignee: Hyundai Motor Company, Seoul (KR)

(21) Appl. No.: 13/489,844

(22) Filed: Jun. 6, 2012

(30) Foreign Application Priority Data
Nov. 25, 2011 (KR) 10-2011-0124459

(51) Int. Cl. B60H 1/00; F28F 3/00; F01P 3/14; G05D 23/00; F01P 7/14

(52) U.S. Cl. 165/296; 165/297; 165/299; 165/166

(57) ABSTRACT

A heat exchanger may include a heat radiating portion provided with first, second, and third connecting lines formed in a predetermined sequence by stacking a plurality of plates, and receiving first, second, and third operating fluids respectively into the first, second, and third connecting lines. The first, second, and third operating fluids exchange heat with each other but are not mixed with each other. The heat exchanger may include a bifurcating portion connecting an inflow hole for flowing one operating fluid of the first, second, and third operating fluids with an exhaust hole and adapted for the one operating fluid to bypass the heat radiating portion according to a temperature of the one operating fluid, and a valve unit adapted to flow the one operating fluid selectively into the heat radiating or bifurcating portions according to a temperature of the one operating fluid flowing into the inflow hole.

### CROSS-REFERENCE TO RELATED APPLICATION

The present application claims priority of Korean Patent Application Number 10-2011-0124459 filed in the Korean Intellectual Property Office on Nov. 25, 2011, the entire content of which application is incorporated herein for all purposes by this reference.

### BACKGROUND OF INVENTION

1. Field of Invention

The present invention relates to a heat exchanger for a vehicle. More particularly, the present invention relates to a heat exchanger for a vehicle that can control temperatures of operating fluids that flows in the heat exchanger.

2. Description of Related Art

Generally, a heat exchanger transfers heat from high-temperature fluid to low-temperature fluid through a heat transfer surface, and is used in a heater, a cooler, an evaporator, and a condenser.

Such a heat exchanger reuses heat energy or controls a temperature of an operating fluid flowing therein for demanded performance. The heat exchanger is applied to an air conditioning system or a transmission oil cooler of a vehicle, and is mounted at an engine compartment.

Since the heat exchanger is hard to be mounted at the engine compartment with restricted space, studies for the heat exchanger with smaller size, lighter weight, and higher efficiency have been developed.

A conventional heat exchanger controls the temperatures of the operating fluids according to a condition of a vehicle and supplies the operating fluids to an engine, a transmission, or an air conditioning system. For this purpose, bifurcation circuits and valves are mounted on each hydraulic line through which the operating fluids operated as heating medium or cooling medium passes. Therefore, constituent elements and assembling processes increase and layout is complicated.

If additional bifurcation circuits and valves are not used, heat exchanging efficiency cannot be controlled according to flow amount of the operating fluid. Therefore, the temperature of the operating fluid cannot be controlled effectively.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present application are made to provide a heat exchanger for a vehicle having advantages of simultaneously warming up and cooling operating fluids according to temperatures of the operating fluids at a running state or an initial starting condition of the vehicle when the operating fluids exchange heat with each other in the heat exchanger.

Various aspects of the present application are made to provide a heat exchanger for a vehicle having further advantages of improving fuel economy and heating performance by controlling temperatures of operating fluids according to conditions of the vehicle, and advantages of reducing assembling processes by simplifying a structure of the heat exchanger.

A heat exchanger for a vehicle according to various exemplary embodiments of the present application may include a heat radiating portion provided with first, second, and third connecting lines formed in a predetermined sequence by stacking a plurality of plates, and receiving first, second, and third operating fluids respectively into the first, second, and third connecting lines, the first, second, and third operating fluids exchanging heat with each other during passing through the first, second, and third connecting lines and the first, second, and third operating fluids supplied to the first, second, and third connecting lines not being mixed with each other and being circulated; a bifurcating portion connecting an inflow hole for flowing one operating fluid of the first, second, and third operating fluids with an exhaust hole for exhausting the one operating fluid, and adapted for the one operating fluid to bypass the heat radiating portion according to a temperature of the one operating fluid; and a valve unit mounted at a position corresponding to the inflow hole and adapted to flow the one operating fluid selectively into the heat radiating portion or the bifurcating portion according to a temperature of the one operating fluid flowing into the inflow hole.

The first operating fluid may flow into the heat radiating portion through a first inflow hole and may flow out from the heat radiating portion through a first exhaust hole, and the first inflow hole may be connected to the first exhaust hole through the first connecting line.

The second operating fluid may flow into the heat radiating portion through a second inflow hole and may flow out from the heat radiating portion through a second exhaust hole, and the second inflow hole may be connected to the second exhaust hole through the second connecting line.

The third operating fluid may flow into the heat radiating portion through a third inflow hole and may flow out from the heat radiating portion through a third exhaust hole, and the third inflow hole may be connected to the third exhaust hole through the third connecting line.

The first, second, and third inflow holes may be formed at both sides of a surface of the heat radiating portion substantially along a length direction, and the first, second, and third exhaust holes may be disposed apart from the first, second, and third inflow holes and be formed at the both sides of the surface of the heat radiating portion substantially in the length direction.

The bifurcating portion may be adapted to connect the first inflow hole to the first exhaust hole, and may be protruded from the surface of the heat radiating portion.

The first inflow hole and the first exhaust hole may be formed at corner portions of the surface of the heat radiating portion facing substantially diagonally with each other.

The second inflow hole and the second exhaust hole may be formed at corner portions of the surface of the heat radiating portion at which the first inflow hole and the first exhaust hole are not positioned and which face substantially diagonally with each other.

The third inflow hole and the third exhaust hole may be formed at the corner portions of the surface of the heat radiating portion at which the second inflow hole and the second exhaust hole are formed and may be disposed apart from the second inflow hole and the second exhaust hole respectively.

The first operating fluid may be a coolant flowing from a radiator, the second operating fluid may be a transmission oil flowing from an automatic transmission, and the third operating fluid may be an engine oil flowing from an engine.

In various embodiments, the coolant may circulate through the first inflow hole, the first connecting line, and the first exhaust hole, the transmission oil may circulate through the second inflow hole, the second connecting line, and the second exhaust hole, and the engine oil may circulate through the third inflow hole, the third connecting line, and the third exhaust hole, wherein the second connecting line is positioned under the first connecting line and the third connecting line is positioned above the first connecting line.

In another exemplary embodiment, the coolant may circulate through the first inflow hole, the first connecting line, and the first exhaust hole, the transmission oil may circulate through the second inflow hole, the second connecting line, and the second exhaust hole, and the engine oil may circulate through the third inflow hole, the third connecting line, and the third exhaust hole, wherein the second connecting line or the third connecting line is disposed between the two neighboring first connecting lines and the second connecting line and the third connecting line are disposed alternately.

The bifurcating portion may be provided with a bypass line adapted to flow the coolant flowing in the bifurcating portion through the first inflow hole to the first exhaust hole directly.

The valve unit may include a mounting cap fixedly mounted at a surface of the heat radiating portion that is opposite to the surface of the heat radiating portion at which the first inflow hole is formed; and a deformable member inserted in the mounting cap and adapted to extend or contract according to the temperature of the operating fluid.

The deformable member may be made from shape memory alloy adapted to extend or contract according to the temperature of operating fluid.

The deformable member may include a pair of fixed portions positioned at both sides thereof substantially in a length direction and adapted not to being deformed according to the temperature of the operating fluid; and a deformable portion disposed between the pair of fixed portions and adapted to extend or contract according to the temperature of the operating fluid.

The deformable member may be formed by overlapping and contacting a plurality of ring members with each other in a coil spring shape.

The mounting cap may include: a mounting portion fixedly mounted at the heat radiating portion; and a guide portion extending from the mounting portion toward the first inflow hole and adapted to guide the deformable member in a case that the deformable member inserted therein is deformed.

A screw may be formed at an exterior circumference of the mounting portion so as to be threaded to the heat radiating portion.

At least one of through-holes may be formed at an exterior circumference of the guide portion.

The heat exchanger may further include a sealing for preventing the operating fluid passing through the heat radiating portion from leaking to the exterior, wherein the sealing is mounted between the mounting portion and the guide portion.

The heat radiating portion may cause the first operating fluid to exchange heat with the second and third operating fluids by counterflow of the first operating fluid and the second and third operating fluids.

The heat radiating portion may be a heat radiating portion of plate type where a plurality of plates is stacked.

The methods and apparatuses of the present application have other features and advantages which will be apparent from or are set forth in more detail in the accompanying drawings, which are incorporated herein, and the following Detailed Description, which together serve to explain certain principles of the present application.

### BRIEF DESCRIPTION OF THE DRAWINGS

FIG. 1 is a schematic diagram of an exemplary cooling system of an automatic transmission to which an exemplary heat exchanger for a vehicle according to the present application is applied.

FIG. 2 is a perspective view of an exemplary heat exchanger for a vehicle according to the present application.

FIG. 3 is a partially cut-away perspective view of an exemplary heat exchanger for a vehicle according to the present application.

FIG. 4 is a cross-sectional view taken along the line A-A in FIG. 2.

FIG. 5 is a cross-sectional view taken along the line B-B in FIG. 2.

FIG. 6 is a cross-sectional view taken along the line C-C in FIG. 2.

FIG. 7 is a cross-sectional view for showing arrangement of connecting lines in an exemplary heat exchanger for a vehicle according to the present application.

FIG. 8 is a cross-sectional view for showing arrangement of connecting lines in an exemplary heat exchanger for a vehicle according to the present application.

FIG. 9 is a perspective view of a valve unit used in an exemplary heat exchanger for a vehicle according to the present application.

FIG. 10 is an exploded perspective view of an exemplary valve unit according to the present application.

FIG. 11 is a perspective view of an exemplary valve unit at an extended state according to the present application.

FIG. 12 to FIG. 14 are perspective and cross-sectional views for describing operation of an exemplary heat exchanger for a vehicle according to the present application.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

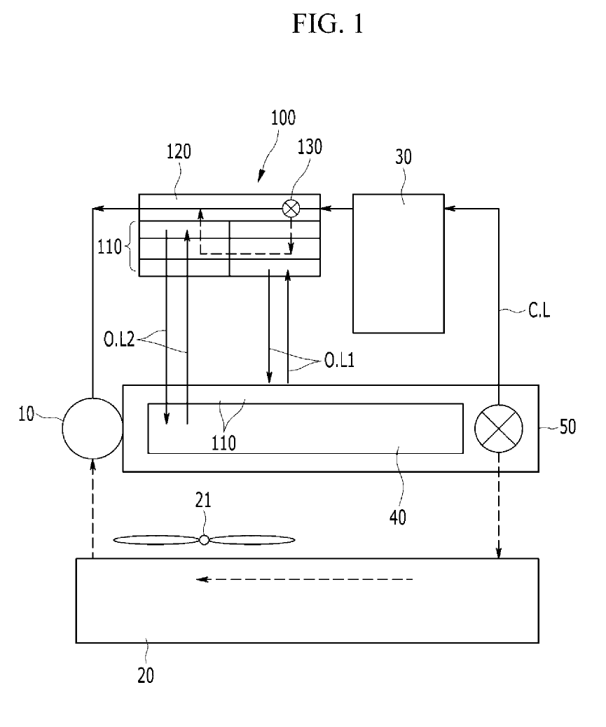

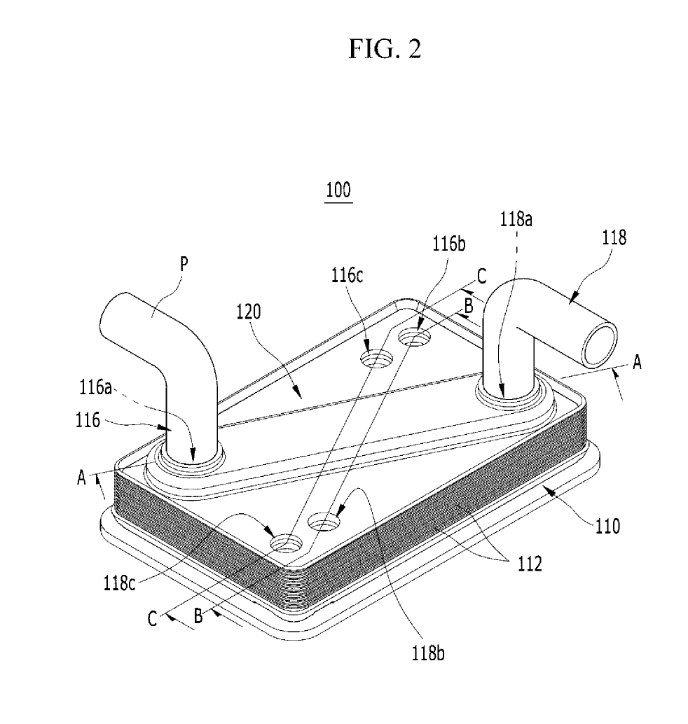

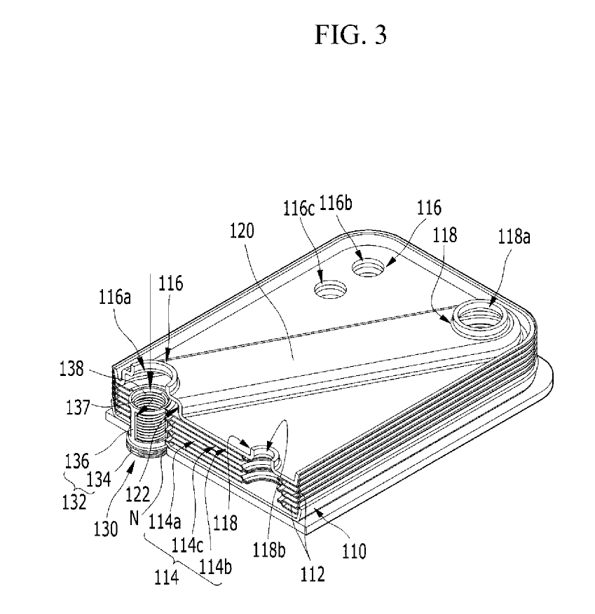

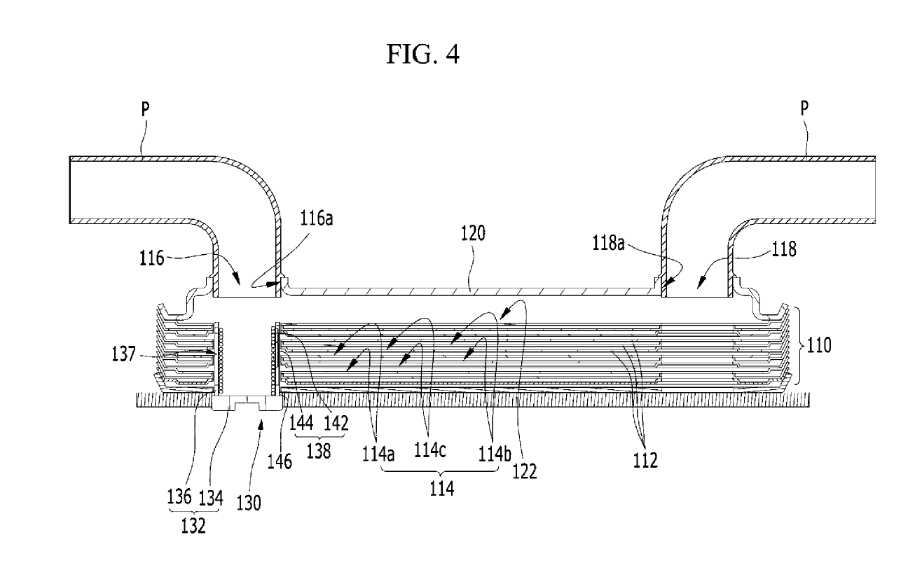

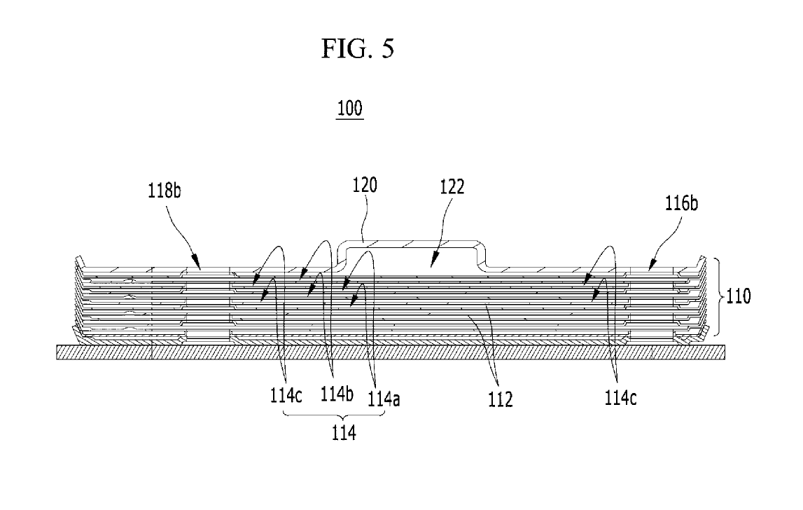

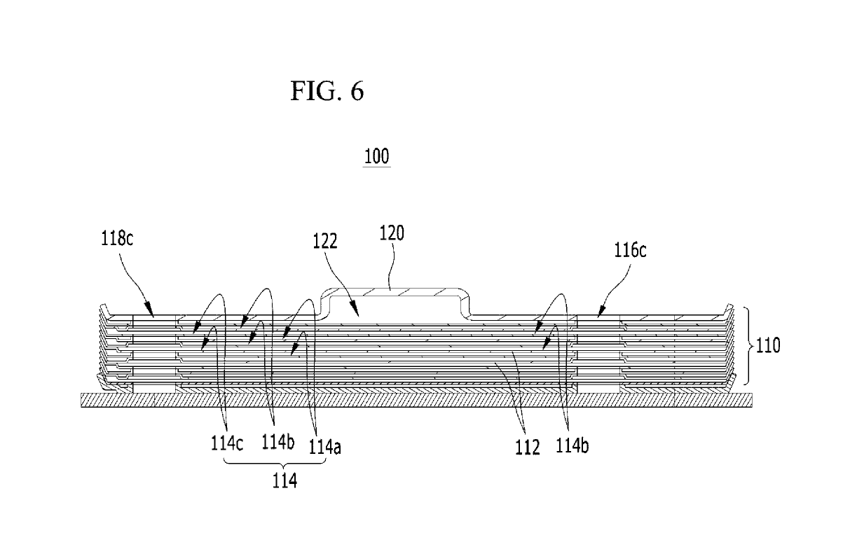

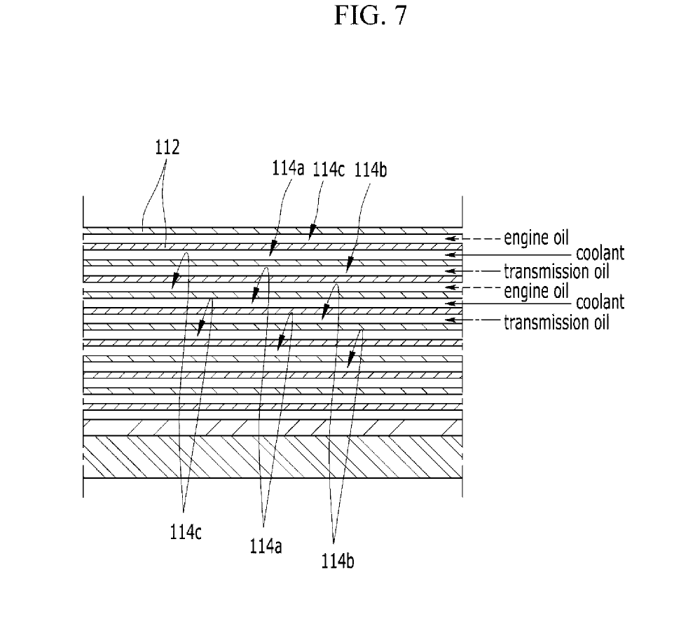

FIG. 1 is a schematic diagram of a cooling system of an automatic transmission to which a heat exchanger for a vehicle according to various embodiments of the present application is applied; FIG. 2 is a perspective view of a heat exchanger for a vehicle according to various embodiments of the present application; FIG. 3 is a partially cut-away perspective view of a heat exchanger for a vehicle according to various embodiments of the present application; FIG. 4 is a cross-sectional view taken along the line A-A in FIG. 2; FIG. 5 is a cross-sectional view taken along the line B-B in FIG. 2; FIG. 6 is a cross-sectional view taken along the line C-C in FIG. 2; and FIG. 7 is a cross-sectional view for showing arrangement of connecting lines in a heat exchanger for a vehicle according to various embodiments of the present application.

Referring to the drawings, a heat exchanger 100 for a vehicle according to various embodiments of the present application applies to a cooling system of an automatic transmission for a vehicle.

The cooling system of the automatic transmission, as shown in FIG. 1, is provided with a cooling line C.L for cooling an engine 50. A coolant passes through the radiator 20 having a cooling fan 21 through a water pump 10 and is cooled by the radiator 20. A heater core 30 connected to a heating system of the vehicle is mounted at the cooling line C.L.

A heat exchanger 100 for a vehicle according to various embodiments of the present application warms up or cools operating fluids according to temperatures of the operating fluids flowing in at a running state or an initial starting condition of the vehicle when the temperatures of the operating fluids are controlled in the heat exchanger 100 through heat exchange.

For this purpose, the heat exchanger 100 for a vehicle according to various embodiments of the present application is disposed between the water pump 10 and the heater core 30, and is connected to an automatic transmission 40 and the engine 50 through first and second oil lines 011 and 012.

That is, the operating fluids includes a coolant flowing from the radiator 20, a transmission oil flowing from the automatic transmission 40, and an engine oil flowing from the engine 50 according to the various embodiments. The heat exchanger 100 causes transmission oil and the engine oil to exchange heat with the coolant such that temperatures of the transmission oil and the engine oil are controlled.

The heat exchanger 100, as shown in FIG. 2 to FIG. 6, includes a heat radiating portion 110, a bifurcating portion 120 and a valve unit 130, and each constituent element will be described in detail.

The heat radiating portion 110 is formed by stacking a plurality of plates 112, and a plurality of connecting lines 114 is formed between the neighboring plates 112. In addition, the coolant flows through one of the neighboring three connecting lines 114, the transmission oil flows through another of the neighboring three connecting lines 114, and the engine oil flows through the other of the neighboring three connecting lines 114. At this time, the coolant exchanges heat with the transmission oil and the engine oil.

In addition, the operating fluid supplied to the connecting line 114 is not mixed with other operating fluid supplied to other connecting line 114.

Herein, the heat radiating portion 110 causes the coolant to exchange heat with the transmission oil and the engine oil by counterflow of the coolant and the transmission and engine oils.

By way of illustration, the heat radiating portion 110 is a heat radiating portion of plate type where the plurality of plates 112 is stacked. It will be appreciated that other suitable types, such as disk type, can be used and are within the scope of the present application.

In addition, the bifurcating portion 120 connects one of inflow holes 116 for flowing the operating fluids into the heat radiating portion 110 with one of exhaust holes 118 for discharging the operating fluids from the heat radiating portion 110, and is mounted at an exterior of the heat radiating portion 110.

The bifurcating portion 120 is configured to detour the operating fluid by the valve unit 130 operated according to the temperature of the operating fluid.

The inflow holes 116 includes first, second, and third inflow holes 116a, 116b, and 116c formed at both sides of a surface of the heat radiating portion 110 substantially along a length direction according to various embodiments.

In addition, the exhaust holes 118 includes first, second, and third exhaust holes 118a, 118b, and 118c formed at the both sides of the surface of the heat radiating portion 110 substantially along the length direction. The first, second, and third exhaust holes 118a, 118b, and 118c correspond to the first, second, and third inflow holes 116a, 116b, and 116c and are distanced from the first, second, and third inflow holes 116a, 116b, and 116c.

The first, second, and third exhaust holes 118a, 118b, and 118c are connected respectively to the first, second, and third inflow holes 116a, 116b, and 116c through the respective connecting line 114 in the heat radiating portion 110.

The first inflow hole 116a and the first exhaust hole 118a are formed generally at corner portions of the surface of the heat radiating portion 110 diagonally.

The second inflow hole 116b and the second exhaust hole 118b are formed generally at corner portions of the surface of the heat radiating portion 110 diagonally, and confront respectively with the first inflow hole 116a and the first exhaust hole 118a.

In addition, the third inflow hole 116c and the third exhaust hole 118c are formed at the corner portions of the surface of the heat radiating portion 110 where the second inflow hole 116b and the second exhaust hole 118b are formed, and are disposed apart from the second inflow hole 116b and the second exhaust hole 118b respectively. The third inflow hole 116c and the third exhaust hole 118c confront respectively with the first inflow hole 116a and the first exhaust hole 118a.

The bifurcating portion 120 connects the first inflow hole 116a with the first exhaust hole 118a, and is protruded from the surface of the heat radiating portion 110.

According to various embodiments, the coolant circulates through the first inflow hole 116a and the first exhaust hole 118a, the transmission oil circulates through the second inflow hole 116b and the second exhaust hole 118b, and the engine oil circulates through the third inflow hole 116c and the third exhaust hole 118c. This arrangement is an example and is not limiting.

Connecting ports P may be mounted respectively at the first, second, and third inflow holes 116a, 116b, and 116c and the first, second, and third exhaust holes 118a, 118b, and 118c, and are connected to the radiator 20, the automatic transmission 40, and the engine 50 through connecting hoses connected to the connecting ports P.

For clarity, the connecting ports mounted at the second and third inflow holes 116b and 116c and the second and third exhaust holes 118b and 118c are not shown in the drawings.

According to various embodiments, the connecting line 114, as shown in FIG. 7, includes first, second, and third connecting lines 114a, 114b, and 114c, and will be described in detail.

The first connecting line 114a is adapted to flow the coolant flowing into the heat radiating portion 110 through the first inflow hole 114a.

In various embodiments, the second connecting line 114b is disposed under the first connecting line 114a and the transmission oil flowing in the heat radiating portion 110 through the second inflow hole 116b flows through the second connecting lines 114b.

In addition, the third connecting line 114c is disposed above the first connecting line 114a and the engine oil flowing in the heat radiating portion 110 through the third inflow hole 116c flows through the third connecting line 114c.

Herein, the first connecting line 114a, the second connecting line 114b disposed under the first connecting line 114a, and the third connecting line 114c disposed above the first connecting line 114a constitute one set of connecting lines. A plurality of sets of connecting lines 114 may be formed in the heat radiating portion 110.

That is, the first connecting line 114a in which the coolant flows is positioned at a center portion of the set, and the second and third connecting lines 114b and 114c are disposed under and above the first connecting line 114a. Therefore, the connecting line 114 is configured for the coolant to exchange heat with the transmission oil and the engine oil.

That is, the second connecting line 114b through which the transmission oil flows is disposed between the first and third connecting lines 114a and 114c through which the coolant and the engine oil flow respectively. Therefore, in a case that a temperature of the transmission oil should be raised at an initial starting of the vehicle or an idle mode, the temperature of the transmission oil may be quickly raised through the second connecting line 114b disposed between the first and third connecting lines 114a and 114c.

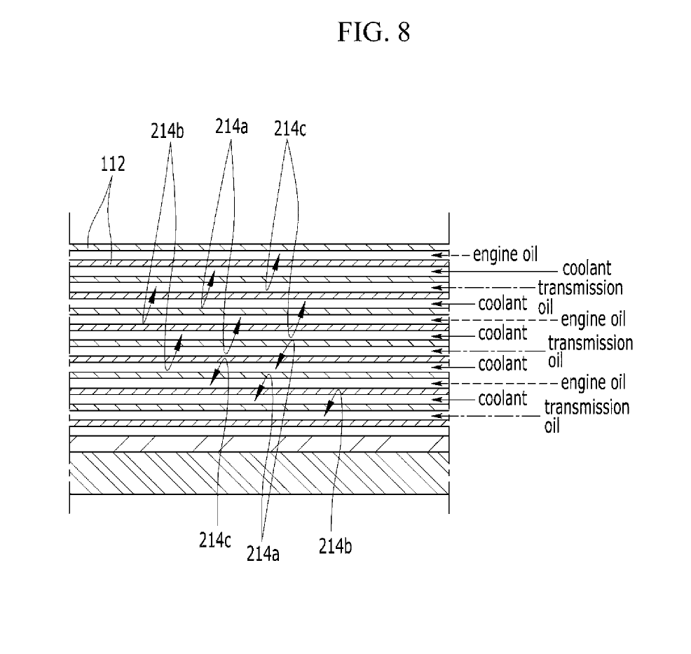

Meanwhile, arrangement of connecting lines in a heat exchanger for a vehicle according to various embodiments of the present application will be described in detail with reference to FIG. 8.

FIG. 8 is a cross-sectional view for showing arrangement of connecting lines in a heat exchanger for a vehicle according to various embodiments of the present application.

Referring to the drawing, the first connecting line 214a through which the coolant flows is alternately formed with the second and third connecting lines 214b and 214c through which the transmission oil and the engine oil flow respectively in various embodiments of the present application. That is, the second connecting line 214b or the third connecting line 214c is formed between two neighboring first connecting lines 214a, and the second connecting line 214b and the third connecting line 214c are alternately disposed.

Since the second connecting line 214b or the third connecting line 214c is formed between two neighboring first connecting lines 214a and the second connecting line 214b and the third connecting line 214c are alternately disposed, the coolant passing through the first connecting line 214a exchanges with the transmission oil and the engine oil passing through the second and third connecting lines 214b and 214c.

Therefore, the heat exchanger 200 for the vehicle according to various embodiments of the present application may improve cooling performance as a consequence that the coolant flows above and under the transmission oil and the engine oil and exchanges heat with the transmission oil and the engine oil in a case that the transmission oil and the engine oil should be cooled depending on a running state of the vehicle.

Herein, the bifurcating portion 120 includes a bypass line 122 formed at a position close to the first inflow hole 116a and the first exhaust hole 118b. The bypass line 122 is adapted to exhaust the coolant flowing into the first inflow hole 116a directly to the first exhaust hole 118a, not passing through the first connecting line 114a.

In addition, the valve unit 130 is mounted at the heat radiating portion 110 corresponding to the first inflow hole 116a, and flows the coolant to the heat radiating portion 110 or to the bypass line 122 according to the temperature of the coolant.

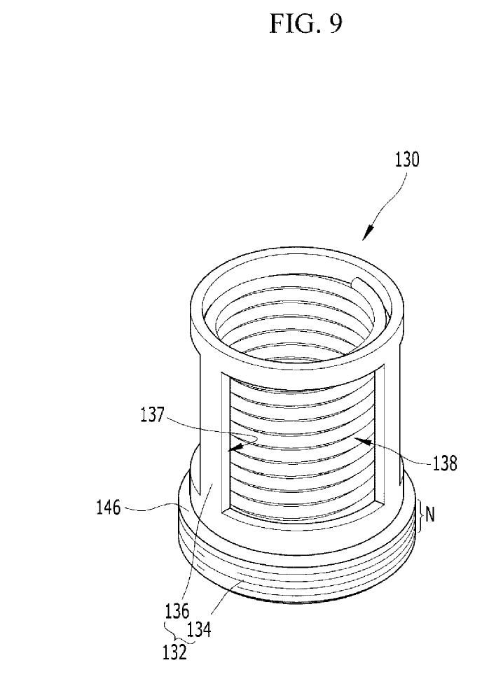

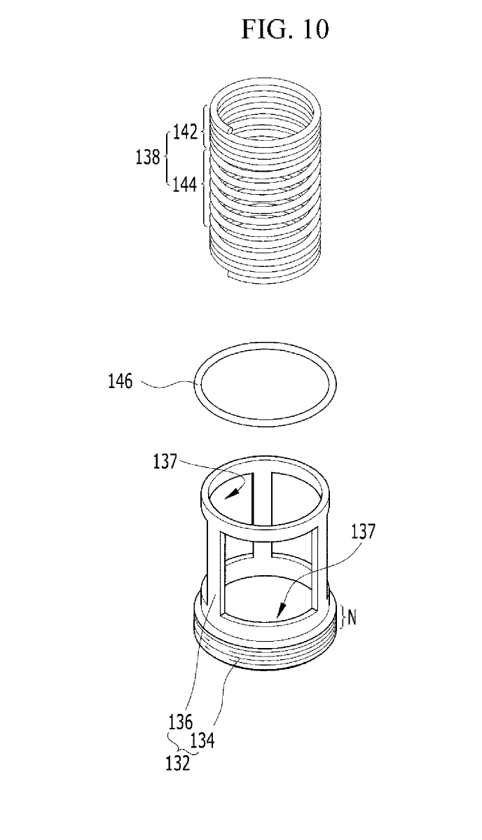

The valve unit 130 will be described in detail with reference to FIG. 9 and FIG. 10.

FIG. 9 and FIG. 10 are a perspective view and an exploded perspective view of a valve unit used in a heat exchanger for a vehicle according to various embodiments of the present application.

Referring to the drawings, the valve unit 130 includes a mounting cap 132 and a deformable member 138, and the mounting cap 132 and the deformable member 138 will be described in detail.

The mounting cap 132 is fixedly mounted at the other surface of the heat radiating portion 110 that is opposite to the first inflow hole 116a.

The mounting cap 132 includes a mounting portion 134 fixedly mounted at the heat radiating portion 110 and a guide portion 136 extending from the mounting portion 134 toward the first inflow hole 116a. The deformable member 138 is inserted in the guide portion 136. The guide portion 136 guides the deformable member 138 when the deformable member 138 extends or contracts.

A screw N is formed at an exterior circumference of the mounting portion 134 such that the mounting portion 134 is threaded to an interior circumference of the heat radiating portion 110, and tab forming corresponding to the screw N is performed at the interior circumference of the other surface of the heat radiating portion 110 corresponding to the first inflow hole 116a.

In addition, at least one of through-hole 137 is formed at an exterior circumference of the guide portion 136. The through-hole 137 is configured so that the coolant flowed in the extended deformable member 138 flows to the first connecting line 114a of the heat radiating portion 110 smoothly.

According to various embodiments, a sealing 146 is mounted at the mounting cap 132 so as to prevent the coolant from leaking. The sealing 146 may be mounted between the mounting portion 134 and the guide portion 136.

That is, the sealing 146 seals a gap between the interior circumference of the heat radiating portion 110 and the exterior circumference of the mounting portion 134 such that the operating fluid is prevented from leaking to the exterior of the heat radiating portion 110 along the screw N of the mounting portion 134 threaded to the heat radiating portion 110.

In addition, the deformable member 138 is inserted in the guide portion 136 of the mounting cap 132, and extends or contracts according to the temperature of the coolant flowed into the first inflow hole 116a.

The deformable member 138 can be made from shape memory alloy or other suitable materials that can extend or contract according to the temperature of the operating fluid.

The shape memory alloy (SMA) is an alloy that remembers a shape at a predetermined temperature. The shape of an element made of the shape memory alloy can change at a different temperature from the predetermined temperature. If the element made of the shape memory alloy is cooled or heated to the predetermined temperature, the shape of the element returns to an original shape.

The deformable member 138 made from the shape memory alloy material includes a pair of fixed portions 142 and a deformable portion 144, and the fixed portion 142 and the deformable portion 144 will be described in detail.

The pair of fixed portions 142 is positioned at both end portions of the deformable member 138 substantially in a length direction, and a shape of the fixed portion does not change according to the temperature. That is, ring members forming the fixed portion 142 are fixed with each other, for example, by welding.

In addition, the deformable portion 144 is positioned between the fixed portion 142, and extends or contracts according to the temperature of the operating fluid. That is, ring members forming the deformable portion 144 is extendably or contractably connected to each other.

The deformable member 138 has a shape similar to that of a circular coil spring. The deformable member 138 is inserted in the guide portion 136 of the mounting cap 132 at a contracted state, and is deformed according to the temperature of the operating fluid flowing in the deformable member 138 through the first inflow hole 116a so as to selectively open or close the first connecting line 114a.

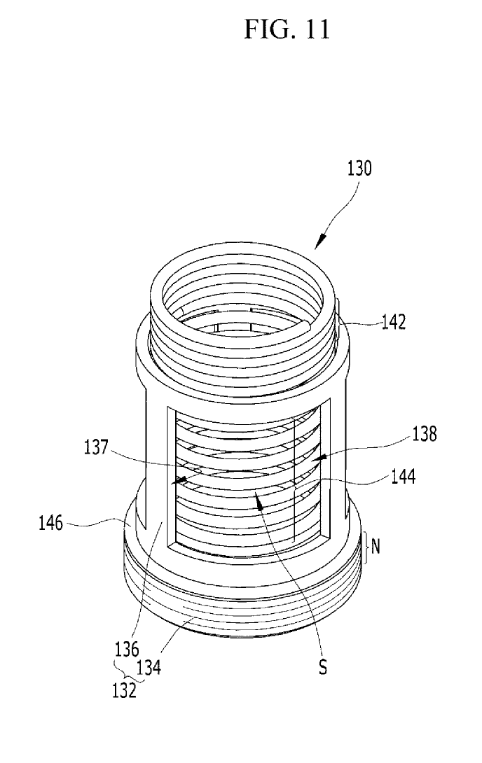

Operation of the valve unit 130 will be described in detail with reference to FIG. 11, which illustrates a perspective view of a valve unit at an extended state according to various embodiments of the present application.

That is, if the operating fluid having a higher temperature than the predetermined temperature flows in the valve unit 130, the deformable portion 144 of the deformable member 138 extends, as shown in FIG. 11.

Accordingly, the ring members forming the deformable portion 144 of the deformable member 138 are distanced from each other so as to form a space S, and the operating fluid flows out through the space S.

At this time, the ring members forming the fixed portion 142 are fixed to each other, and the fixed portion 142 does not extend.

If the operating fluid having a lower temperature than the predetermined temperature flows into the first inflow hole 116a, the deformable portion 144 contracts to an original shape shown in FIG. 9 and the space S is closed.

Operation and function of the heat exchanger 100 according to various embodiments of the present application will be described in detail.

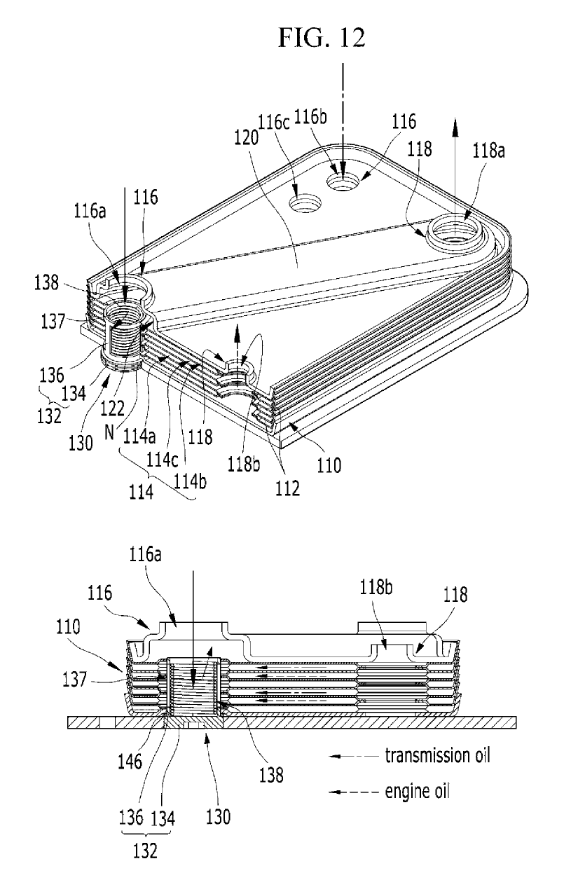

FIG. 12 to FIG. 14 are perspective and cross-sectional views for describing operation of a heat exchanger for a vehicle according to various embodiments of the present application.

If the temperature of the coolant flowing through the first inflow hole 116a is lower than the predetermined temperature, the deformable member 138 of the valve unit 130 does not deform and maintains an original shape as shown in FIG. 12.

The coolant does not flow into the first connecting line 114a of the heat radiating portion 110, but flows directly to the first exhaust hole 118a through the bypass line 122 formed in the bifurcating portion 120. Accordingly, the coolant does not flow into the first connecting line 114a of the heat radiating portion 110.

Then, the transmission oil and the engine oil flow through the second and third inflow holes 116b and 116c and pass through the second and third connecting lines 114b and 114c of the heat radiating portion 110. Since the coolant, does not flow into the first connecting line 114a, the coolant does not exchange heat with the transmission oil and the engine oil.

If the transmission oil and the engine oil should be warmed up according to a condition or a mode of the vehicle such as a running state, an idle mode, or an initial starting, the bypass line 122 prevents the coolant of low temperature from flowing into the first connecting line 114a. Therefore, the temperatures of the transmission oil and the engine oil are prevented to be lowered through heat exchange with the coolant.

Since the transmission oil and the engine oil are supplied to the automatic transmission 40 and the engine 50 in a state of being warmed up, heating performance of the vehicle may be improved.

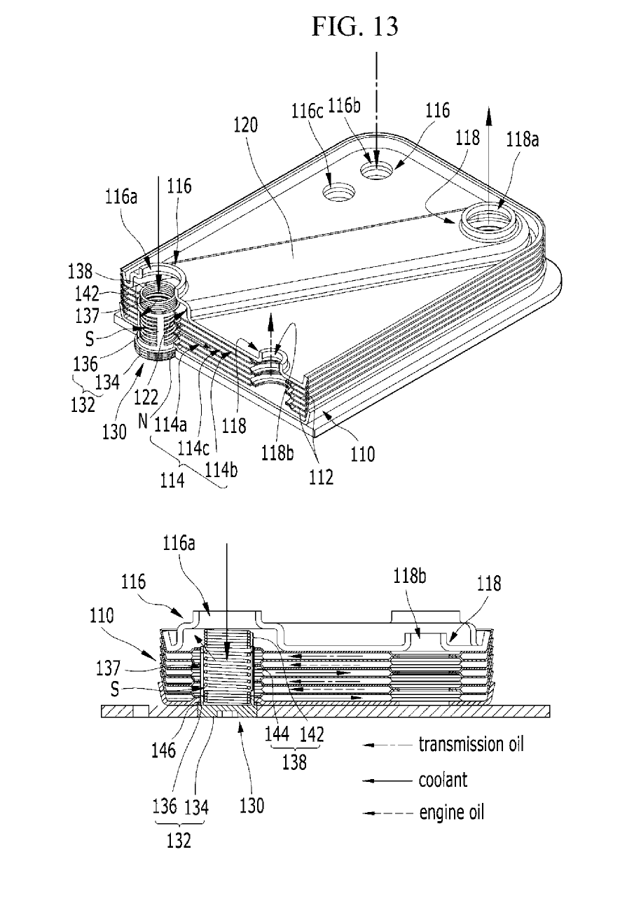

If the temperature of the coolant, on the contrary, is higher than the predetermined temperature, the deformable member 138 of the valve unit 130 extends and the space S is formed between the ring members forming the deformable portion 144 as shown in FIG. 13.

The coolant passing through the first inflow hole 116a flows through the first connecting line 114a. After that, the coolant is discharged through the first exhaust hole 118a.

Therefore, the coolant passes through the first connecting line 114a of the heat radiating portion 110 and exchanges heat with the transmission oil and the engine oil supplied from the automatic transmission 40 and the engine 50 through the second inflow hole 116b and the third inflow hole 116c and passing trough the second and third connecting lines 114b and 114c. Therefore, the temperatures of the coolant, the transmission oil, and the engine oil are controlled in the heat radiating portion 110.

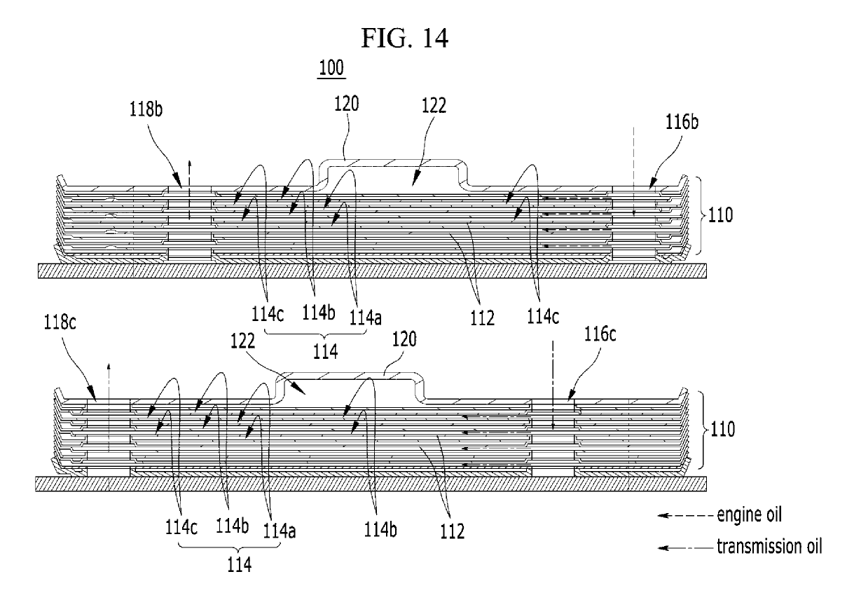

Herein, the transmission oil and the engine oil, as shown in FIG. 14, are supplied respectively through the second inflow hole 116b and the third inflow hole 116c.

The transmission oil and the engine oil passes through the second and third connecting lines 114b and 114c formed under and above the first connecting line 114a in the heat radiating portion 110. After that, the transmission oil and the engine oil are exhausted from the heat radiating portion 110 through the second exhaust hole 118b and the third exhaust hole 118c, and are supplied respectively to the automatic transmission 40 and the engine 50.

At this time, the coolant selectively flows to the first connecting line 114a by the valve unit 130 operated according to the temperature of the coolant, and exchanges heat with the transmission oil and the engine oil passing through the second and third connecting lines 114b and 114c.

Herein, the coolant and the transmission oil flow to opposite directions and exchange heat with each other, and the coolant and the engine oil flow to opposite directions and exchange heat with each other. Therefore, the transmission oil and the engine oil exchange heat with the coolant more efficiently.

Therefore, the transmission oil and the engine oil, the temperatures of which are raised by operation of a torque converter and the engine 50, are cooled through heat exchange with the coolant in the heat radiating portion 110 and are then supplied to the automatic transmission 40 and the engine 50.

That is, since the heat exchanger 100 supplies the cooled transmission oil and the cooled engine oil to the automatic transmission 40 rotating with a high speed and to the engine 50, occurrence of slip in the automatic transmission 40 and occurrence of knocking and rancidity in the engine 50 are prevented.

In addition, the engine oil and the transmission oil exchanges heat faster with the coolant in the heat radiating portion 110 when the vehicle runs with middle/high speed after being started. After that, the transmission oil and the engine oil are supplied to the automatic transmission 40 and the engine 50. Therefore, friction loss in the automatic transmission 40 and the engine 50 may be lowered and fuel economy may be improved.

If the heat exchanger 100 according to various embodiments of the present application is applied, the operating fluids can be warmed up and cooled simultaneously by using the temperatures of the operating fluids at the running state or the initial starting condition of the vehicle. Therefore, the temperatures of the operating fluids can be controlled efficiently.

In addition, since the deformable member 138 is made from the shape memory alloy, structure of the valve unit 130 is very simple. Since the valve unit 130 performs conversion of the hydraulic lines of the operating fluid according to the temperature of the operating fluid, flow of the operating fluid can be controlled accurately. Therefore, constituent elements can be simplified and production cost may be curtailed, weight may be reduced, and responsiveness of the valve according to the temperature of the operating fluid may be improved.

Since the temperatures of the operating fluids can be controlled according to the condition of the vehicle, fuel economy and heating performance may be improved.

Since two operating fluids exchange heat with the coolant through one heat exchanger, structure and package may be simplified and assembling processes may be reduced.

Since additional bifurcation circuits are not needed, production cost may be curtailed, workability and utilization of space in a small engine compartment may be improved, and a layout of connecting hoses may be simplified.

If the operating fluid is the transmission oil in the automatic transmission 40, hydraulic friction at a cold starting may be lowered due to fast warm up. In addition, slip may be prevented and durability may be maintained at driving due to excellent cooling performance. Therefore, fuel economy and durability of the transmission may be improved.

Since the transmission oil and the engine oil are warmed up and cooled down by using the coolant, heat exchange efficiency, cooling performance, and heating performance may be improved compared with an air-cooled type heat exchanger.

It is exemplified in this specification that the coolant, the transmission oil, and the engine oil are used as the operating fluids, but the operating fluids are not limited to these. All the operating fluids that require warming up or cooling can be used.

In addition, the heat exchanger according to various embodiments may further include covers and brackets that prevent damage of the heat exchanger and other components or that are used for fixing the heat exchanger to other components or the engine compartment.

For convenience in explanation and accurate definition in the appended claims, the terms “upper” or “lower”, “interior” or “exterior”, and etc. are used to describe features of the exemplary embodiments with reference to the positions of such features as displayed in the figures.

The foregoing descriptions of specific exemplary embodiments of the present application have been presented for purposes of illustration and description. They are not intended to be exhaustive or to limit the application to the precise forms disclosed, and obviously many modifications and variations are possible in light of the above teachings. The exemplary embodiments were chosen and described in order to explain certain principles of the application and their practical application, to thereby enable others skilled in the art to make and utilize various exemplary embodiments of the present application, as well as various alternatives and modifications thereof. It is intended that the scope of the application be defined by the Claims appended hereto and their equivalents.

What is claimed is:

1. A heat exchanger for a vehicle, comprising:
a heat radiating portion provided with first, second, and third connecting lines formed in a predetermined sequence by stacking a plurality of plates, and receiving first, second, and third operating fluids respectively into the first, second, and third connecting lines, the first, second, and third operating fluids exchanging heat with each other during passing through the first, second, and third connecting lines and the first, second, and third operating fluids supplied to the first, second, and third connecting lines not being mixed with each other and being circulated;
a bifurcating portion connecting an inflow hole for flowing one operating fluid of the first, second, and third operating fluids with an exhaust hole for exhausting the one operating fluid, and adapted for the one operating fluid to bypass the heat radiating portion according to a temperature of the one operating fluid; and
a valve unit mounted at a position corresponding to the inflow hole and adapted to flow the one operating fluid selectively into the heat radiating portion or the bifurcating portion according to a temperature of the one operating fluid flowing into the inflow hole.

2. The heat exchanger of claim 1, wherein the first operating fluid flows into the heat radiating portion through a first inflow hole and flows out from the heat radiating portion through a first exhaust hole, and the first inflow hole is connected to the first exhaust hole through the first connecting line,
the second operating fluid flows into the heat radiating portion through a second inflow hole and flows out from the heat radiating portion through a second exhaust hole, and the second inflow hole is connected to the second exhaust hole through the second connecting line,
the third operating fluid flows into the heat radiating portion through a third inflow hole and flows out from the heat radiating portion through a third exhaust hole, and the third inflow hole is connected to the third exhaust hole through the third connecting line,
the first, second, and third inflow holes are formed at both sides of a surface of the heat radiating portion substantially along a length direction, and
the first, second, and third exhaust holes are disposed apart from the first, second, and third inflow holes and are formed at the both sides of the surface of the heat radiating portion substantially in the length direction.

3. The heat exchanger of claim 2, wherein the bifurcating portion is adapted to connect the first inflow hole to the first exhaust hole, and is protruded from the surface of the heat radiating portion.

4. The heat exchanger of claim 2, wherein the first inflow hole and the first exhaust hole are formed at corner portions of the surface of the heat radiating portion facing substantially diagonally with each other.

5. The heat exchanger of claim 2, wherein the second inflow hole and the second exhaust hole are formed at corner portions of the surface of the heat radiating portion at which the first inflow hole and the first exhaust hole are not positioned and which face substantially diagonally with each other.

6. The heat exchanger of claim 2, wherein the third inflow hole and the third exhaust hole are formed at the corner portions of the surface of the heat radiating portion at which the second inflow hole and the second exhaust hole are formed and are disposed apart from the second inflow hole and the second exhaust hole respectively.

7. The heat exchanger of claim 2, wherein the first operating fluid is a coolant flowing from a radiator, the second operating fluid is a transmission oil flowing from an automatic transmission, and the third operating fluid is an engine oil flowing from an engine.

8. The heat exchanger of claim 7, wherein the coolant circulates through the first inflow hole, the first connecting line, and the first exhaust hole, the transmission oil circulates through the second inflow hole, the second connecting line, and the second exhaust hole, and the engine oil circulates through the third inflow hole, the third connecting line, and the third exhaust hole, and
wherein the second connecting line is positioned under the first connecting line and the third connecting line is positioned above the first connecting line.

9. The heat exchanger of claim 7, wherein the coolant circulates through the first inflow hole, the first connecting line, and the first exhaust hole, the transmission oil circulates through the second inflow hole, the second connecting line, and the second exhaust hole, and the engine oil circulates through the third inflow hole, the third connecting line, and the third exhaust hole, and
wherein the second connecting line or the third connecting line is disposed between two neighboring first connecting lines and the second connecting line and the third connecting line are disposed alternately.

10. The heat exchanger of claim 7, wherein the bifurcating portion is provided with a bypass line adapted to flow the coolant flowing in the bifurcating portion through the first inflow hole to the first exhaust hole directly.

11. The heat exchanger of claim 2, wherein the valve unit comprises:
a mounting cap fixedly mounted at a surface of the heat radiating portion that is opposite to the surface of the heat radiating portion at which the first inflow hole is formed; and
a deformable member inserted in the mounting cap and adapted to extend or contract according to the temperature of the one operating fluid.

12. The heat exchanger of claim 11, wherein the deformable member is made from shape memory alloy adapted to extend or contract according to the temperature of operating fluid.

13. The heat exchanger of claim 11, wherein the deformable member comprises:
a pair of fixed portions positioned at both sides thereof substantially in a length direction and adapted not to being deformed according to the temperature of the one operating fluid; and
a deformable portion disposed between the pair of fixed portions and adapted to extend or contract according to the temperature of the one operating fluid.

14. The heat exchanger of claim 11, wherein the deformable member is formed by overlapping and contacting a plurality of ring members with each other in a coil spring shape.

15. The heat exchanger of claim 11, wherein the mounting cap comprises:
a mounting portion fixedly mounted at the heat radiating portion; and
a guide portion extending from the mounting portion toward the first inflow hole and adapted to guide the deformable member in a case that the deformable member inserted therein is deformed.

16. The heat exchanger of claim 15, wherein a screw is formed at an exterior circumference of the mounting portion so as to be threaded to the heat radiating portion.

17. The heat exchanger of claim 15, wherein at least one of through-holes is formed at an exterior circumference of the guide portion.

18. The heat exchanger of claim 15, further comprising a sealing for preventing the operating fluid passing through the heat radiating portion from leaking to an exterior,
wherein the sealing is mounted between the mounting portion and the guide portion.

19. The heat exchanger of claim 1, wherein the heat radiating portion causes the first operating fluid to exchange heat with the second and third operating fluids by counterflow of the first operating fluid and the second and third operating fluids.

20. The heat exchanger of claim 1, wherein the heat radiating portion is a heat radiating portion of plate type where a plurality of plates is stacked.
